(19) United States
(12) Patent Application Publication
(10) Pub. No.: US 2021/0334693 A1
(43) Pub. Date: Oct. 28, 2021

(54) AUTOMATED GENERATION OF EXPLAINABLE MACHINE LEARNING

(71) Applicant: Intuit Inc., Mountain View, CA (US)

(72) Inventors: Nitzan BAVLY, Tel Aviv (IL); Yehezkel Shraga RESHEFF, Tel Aviv (IL); Tzvika BARENHOLZ, Tel Aviv (IL); Talia TRON, Tel Aviv (IL)

(73) Assignee: Intuit Inc., Mountain View, CA (US)

(21) Appl. No.: 16/855,523

(22) Filed: Apr. 22, 2020

(51) Int. Cl. G06N 20/00; G06F 16/2457; G06F 16/23; G06N 5/04

(52) U.S. Cl. CPC G06N 20/00; G06N 5/04; G06F 16/2365; G06F 16/24578

(57) ABSTRACT

A computer-implemented method and system are provided to perform a machine learning pipeline process to produce an explainable machine learning model. A computing device may be configured to train a plurality of machine learning models with a set of respective feature datasets to generate an accuracy and explainability property for each trained model. The computing device may evaluate a plurality of the trained machine learning models and select a model as an explainable machine learning model based on at least one of the accuracy and the explainability property.

### BACKGROUND

The present disclosure relates to a machine learning system to produce a pipeline for the automated generation of a machine learning model with explainable artificial intelligence (XAI).

Explainable artificial intelligence (XAI) refers to methods and techniques utilized in the machine learning application of an artificial intelligence (AI) system. The technical challenge of explaining AI decisions is often known as the interpretability problem. The interpretability problem may be solved by explainable machine leaning methods such that decisions and the performance of the AI system can be understood by human experts (e.g., AI system developer, data-scientists, etc.). In this context, explainable machine learning methods and the explanation of black-box models have become problems both theoretically and in application in the machine learning industry.

What has been made clear to large extent is that in some cases it is insufficient to generate post-hoc explanations of black-box predictions from non-explainable models. In these cases, explainable and transparent models are required. However, these models may require entirely different skillsets that currently require human experts to learn new ideas, software libraries, and or replace the more commonly used software with these alternatives.

### BRIEF DESCRIPTION OF THE DRAWINGS

FIG. 1 illustrates a hardware structure of an example computing system in accordance with some embodiments of the present disclosure.

FIG. 2 illustrates a conceptual diagram of a machine learning pipeline platform to implement explainable machine learning according to some embodiments of the present disclosure.

FIG. 3 illustrates an example process that may construct and generate feature datasets accordance with some embodiments of the present disclosure.

FIG. 4 illustrates an example automated explainable AI process according to some embodiments of the present disclosure.

FIG. 5 illustrates example model training results in accordance with some embodiments of the present disclosure.

FIG. 6 illustrates an example process that may produce an explainable model in accordance with some embodiments of the present disclosure.

FIG. 7 is a block diagram of an example computing device in accordance with some embodiments of the present disclosure.

### DETAILED DESCRIPTION

Embodiments of the present disclosure may provide techniques for the automated generation of an explainable artificial intelligence (XAI) model from a selection of various machine learning (ML) models. In one or more embodiments, the selection of the explainable artificial intelligence (XAI) model may be based on the trade-off between a model's accuracy and its explainability.

To address the known issues of developing explainable and transparent models, the disclosed principles may provide an inventive technological approach for implementing explainable machine learning. In one or more embodiments, a combination of automated machine learning (Auto-ML) techniques and explainable AI methods may be utilized to produce an automated explainable machine learning (Auto-XAI) pipeline that may convert any machine learning model to a model with explainable AI without a human expert having to make complicated design choices. The disclosed Auto-XAI pipeline may achieve an improvement to the field of explainable artificial intelligence technology by providing a list of models and parameters as alternatives that may be used to determine which model to use as the explainable artificial intelligence (XAI) model based on a trade-off between accuracy and explainability of the different models.

The embodiments of present disclosure address a practical computer-centric explainability problem of understanding internal features and representations of the modeled data by producing a machine learning model with explainable AI. The automated explainable machine learning system may be implemented as computer programs or application software executed to process feature data by a computing system. The practical explainable machine learning application may be established and deployed to provide machine learning solutions in various data analysis areas such as healthcare, finance, manufacturing, etc.

As used herein, the term “machine learning model” may include any type of a state-of-the-art model such as linear models and non-linear models.

As used herein, the term “feature” or “feature dataset” used to train one or more machine learning models may include any type of features extracted from original data or raw data such as stream data, transaction data, text, image, video, etc.

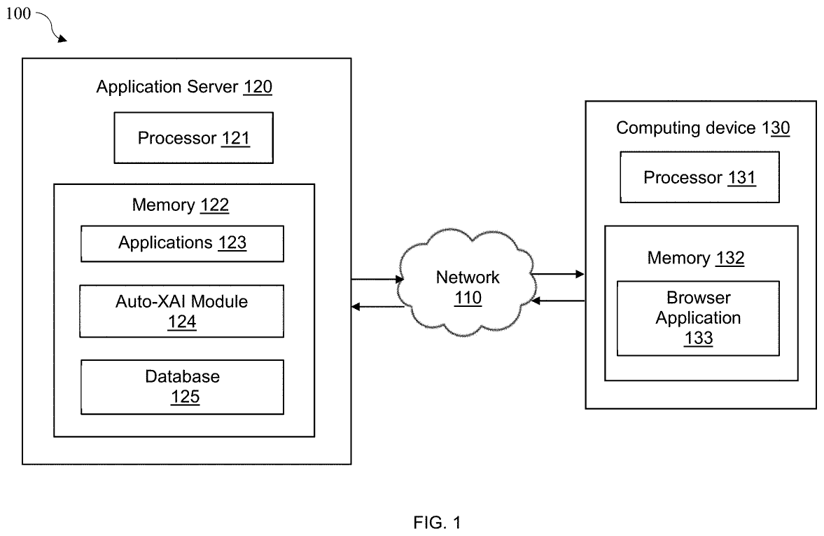

FIG. 1 illustrates an example explainable machine learning or explainable AI system 100 according to some embodiments of the present disclosure. The explainable AI system 100 is an example of a system implemented as computer programs executed on one or more computing devices, in which the systems, model components, processes, and embodiments described in the present disclosure can be implemented.

System 100 may include an application server 120 (e.g., a server computing device) and a user computing device 130 (e.g., a client/user computing device) that may be communicatively connected to one another in a cloud-based or hosted environment by a network 110. Application server 120 may include a processor 121, a memory 122 and a communication interface (not shown) for enabling communication over network 110. Application server 120 may include one or more applications 123 stored in memory 122 and executed by processor 121. Applications 123 may include a practical application for implementing an auto-XAI module 124 for performing any type of machine learning operations such as data predication, classification, etc. The auto-XAI module 124 may be or use one of the components of the applications 123. Further, memory 122 may store the auto-XAI module 124, and other program modules which are implemented in the context of computer-executable instructions and executed by application server 120.

Database 125 of the example system 100 may be included in the application server 120, or coupled to or in communication with the application server 120 via network 110. Database 125 may be a shared remote database, a cloud database, or an on-site central database. Database 125 may receive instructions or data from, and send data to, application server 120. In some embodiments, application server 120 may retrieve and aggregate raw data such as stream data, transaction data, text, image, video, etc., by accessing other servers or databases from various data sources via network 110. Database 125 may store the raw data aggregated by application server 120 and feature data used by the auto-XAI module 124, and output parameters or results of implementation of the auto-XAI module 124. Details related to training and building the auto-XAI module 124 will be described below.

Computing device 130 may include a processor 131, memory 132, and browser application 133. Browser application 133 may facilitate user interaction with application server 120 and may be configured to transmit data to and receive data from application server 120 via network 110. Computing device 130 may be any device configured to present user interfaces and receive inputs thereto. For example, computing device 130 may be a smartphone, personal computer, tablet, laptop computer, or other device.

Application server 120 and computing device 130 are each depicted as single devices for ease of illustration, but those of ordinary skill in the art will appreciate that application server 120, and/or computing device 130 may be embodied in different forms for different implementations. For example, application server 120 may include a plurality of servers communicating with each other through network 110. Alternatively, the operations performed by application server 120 may be performed on a single server. Application server 120 may be in communication with a plurality of computing device devices 130 to receive data within a cloud-based or hosted environment via a network 110. For example, communication between the computing devices may be facilitated by one or more application programming interfaces (APIs). APIs of system 100 may be proprietary and/or may be examples available to those of ordinary skill in the art such as Amazon® Web Services (AWS) APIs or the like. Network 110 may be the Internet or other public or private networks or combinations thereof.

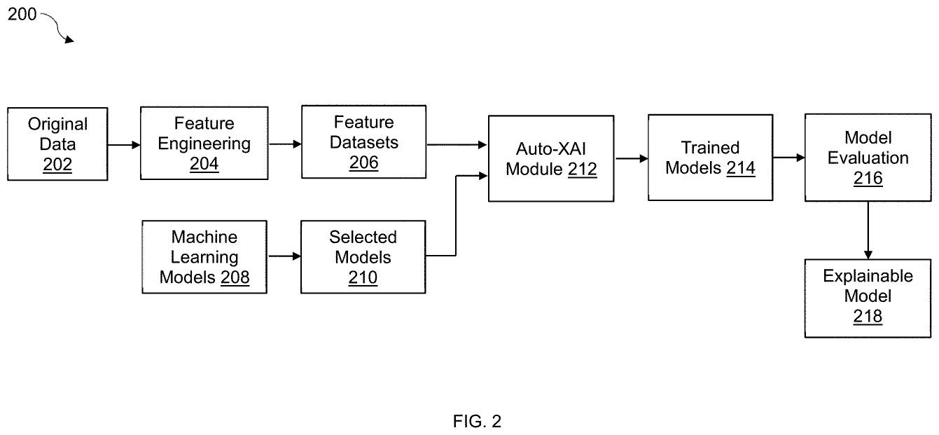

FIG. 2 is a conceptual diagram of an example machine learning pipeline platform of 200 to implement explainable machine learning in accordance with the disclosed principles. The platform 200 may include various software algorithms configured as computer programs (e.g., software) executed on one or more computers, in which the systems, models, algorithms, processes, and embodiments can be implemented various functionalities as described below. The platform 200 may explore different modeling techniques (e.g., machine learning algorithms or models) compatible with training feature dataset and evaluate the performances of the trained models.

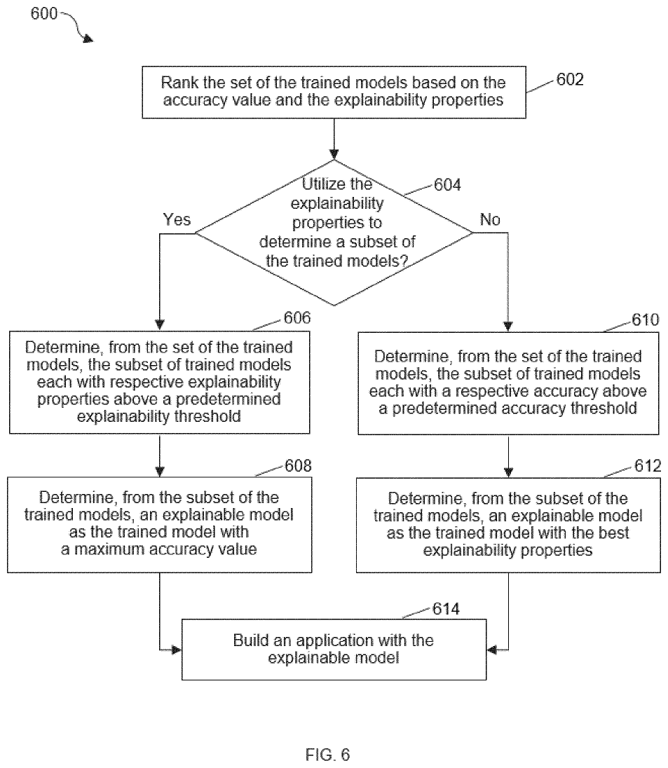

The platform 200 may receive and input original data 202 and may include, among other things, algorithms of various machine learning models 208 with the aim of providing one or more recommended explainable models 218 as described herein. For example, the platform 200 may further include an Auto-XAI module 212 (e.g., Auto-XAI module 124 in FIG. 1) to receive feature datasets 206 (after undergoing feature engineering 204, explained below in more detail) and a selection of models 210 output from the set of models 208. The Auto-XAI module 212 may be configured as computer programs (e.g., software) executed on one or more computers, in which the systems, models, algorithms, processes, and embodiments can be implemented as described below. The Auto-XAI module 212 may be configured to train the selection of models 210 with the feature datasets 206. The model training purpose for solving a developer's particular technical problem may be defined first to select particular models before training the selected models. For example, a model for predicting risk score may be selected and based on user transaction data and behaviors. The auto-XAI module 212 may be configured to extract a subset of models and parameters that may be offered as alternatives, one of which may be selected as the recommended XAI model based on a trade-off between model explainability and model performance. Based on the trained models 214 and training results, application server 120 may conduct a model evaluation 216 process to select a model as an explainable machine learning model 218 to solve the defined technical problem. Details related to evaluating the trained models 214 will be described with reference to FIG. 6 below.

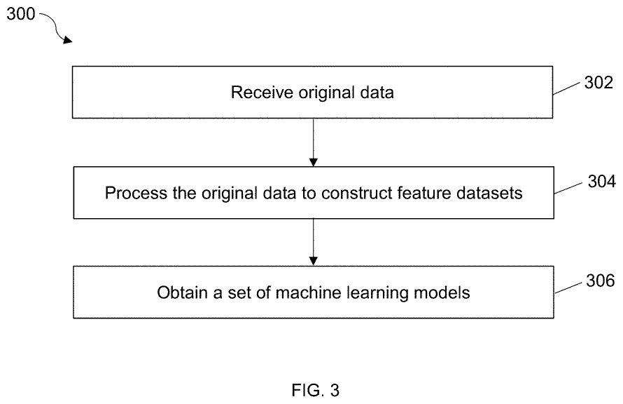

Referring now to FIGS. 2 and 3, an example process 300 that may construct feature datasets 206 and obtain a selection of machine learning models 210 in accordance with some embodiments of the present disclosure is now described.

At step 302, application server 120 may receive and or input original data 202 (e.g., raw data) from the database 125 and or other data resources over the network 110. Based on the original data 202, the model training purpose for solving the developer's particular problem may be defined to construct feature datasets 206 as described below.

At step 304, feature engineering 204 may be performed by the application server 120 to extract and construct a plurality of feature datasets 206, which may be used an input to the auto-XAI module 212. Appropriate features may be selected and extracted to be used as input feature datasets for training purposes. A search in the appropriate parameter space may be automatically conducted to perform feature selection, so that an expert or a developer may not be required to have an intimate understanding of each of the selected models. As part of step 306, Application server 120 may perform preprocessing operations by making slight additions and or modifications to the features to generate the feature datasets 206. In one or more embodiments, a flag may be added to each feature of the dataset 206 to indicate whether the feature has a semantic representation or not. In or more embodiments, explainable machine learning may be conducted to produce explanations of the trained machine learning models 212 based on feature datasets 206 having semantic meanings. All constructed features may be stored in database 125 regardless of subsequent feature selection performed by human experts and or developers.

At step 306, a set of machine learning models 210 may be selected or obtained from the plurality of machine learning models 208. The platform 200 may be provided with a collection of algorithms of a plurality of machine learning models 208. The machine learning models 208 may be any type of a state-of-the-art model, such as linear models or non-liner models. The platform 200 may explore different machine learning algorithms by training different machine leaning models with the feature datasets 206 (e.g., training data). The set of machine learning models 210 may be selected to be compatible with the feature datasets 206 and provided to the auto-XAI module 212 based on a particular model training purpose. For example, a model for predicting risk score may be selected and based on user transaction data and behaviors. In one example, the models 210 may be selected to be compatible with the feature datasets 206 and include GAM, GA2M, small tree based models, etc.

The scope of possible features used to train the models may be virtually unlimited. The instance features may be related to the selected model used. For example, instance features associated with a financial system's data may include user income that may be a numeric value or category (e.g., ‘low’, ‘medium’, ‘high’), credit scores from external providers, and a number of user system logins during an associated period of time, etc. In one example, the data input into the auto-XAI module 212 may include: 1) a set of 300 features used to train the model; and 2) metadata to describe the features. In one or more embodiments, the feature datasets 206 may be associated with data attributes or representation of statistical characteristic of the data 202 (e.g., number of transactions in the past month, size of depth in the last 2 days).

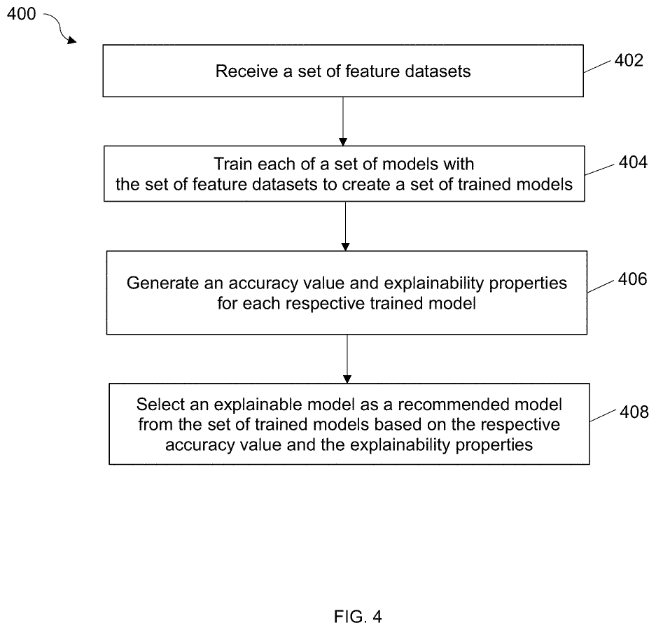

Referring to FIGS. 2 and 4, an example Auto-XAI process 400 that may implement a pipeline to train and convert any model to a model with XAI according to some embodiments disclosed herein is now described. The process 400 may be implemented as a sequence of operations that can be performed by one or more computers including hardware, software, or a combination in the above described systems. Thus, the described operations may be performed with computer-executable instructions under control of one or more processors. The order in which the operations are described is not intended to be construed as a limitation, and any number of the described operations can be combined in any order and/or in parallel to implement the process.

During the Auto-XAI process 400, the auto-XAI module 212 may be implemented to train a set of models with the feature dataset 206 and output parameters. The output parameters may be derived as a result of the training process and outputs of the trained models. Each of these training approaches may be optimized using auto-ML techniques. The auto-XAI module 212 may process and generate a respective output for each model. The automated XAI process 400 may compute a set of complicated models and provide a ranking of each model based on its explainability and accuracy. Accordingly, a developer may select any one of the models based on the rankings and without having to do any additional work on his/her part.

At step 402, the auto-XAI module 212 may input a plurality of sets of feature datasets 206 stored in database 125.

At step 404, application server 120 may execute the Auto-XAI module 212 to train the selected models 210 with the respective input feature datasets 206. The auto-XAI module 212 may process and generate respective trained models 214 with a respective output for each model. Application server 120 may perform model evaluation 216 and model selection 218 of the pipeline platform 200 based on the trained models' outputs. The models 210 may be trained by varying their respective explainability properties. For example, a set of machine learning models 210 may include:

1) XGBoost with monotonicity constrain;

2) XGBoost with 10-50 features instead of 300;

3) GA2M—fully transparent linear model with pairwise interactions; or

4) COREL—a sparse tree which may be read as a small set of rules.

At step 406, based on the training results, application server 120 may execute the auto-XAI module 212 to generate a respective accuracy and provide a respective explainability for each trained model. The model training results may describe model performance of each model in comparison to respective original model.

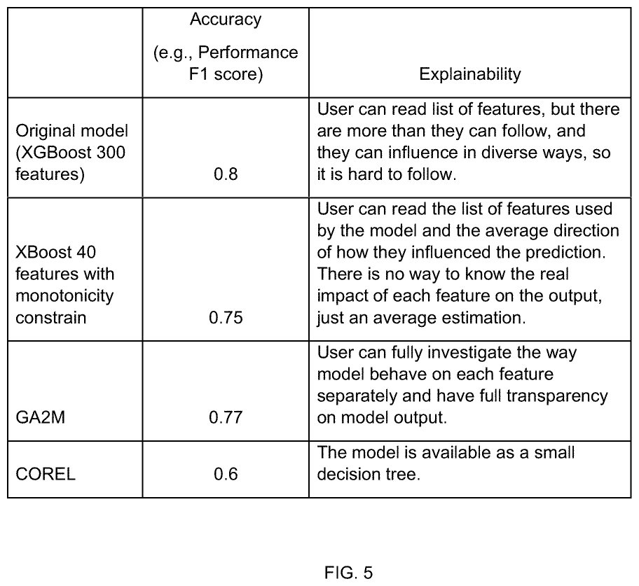

FIG. 5 shows example training results of four example models in accordance with some embodiments of the present disclosure. Each model trained may be optimized using auto-ML techniques. As illustrated in FIG. 5, outputs of the trained models may be used to evaluate the model performance. The model performance may be represented by an accuracy indicative of an accuracy value or performance score (e.g., F1 score) and explainability (also referred to herein as explainability properties). The F1 score is a measure of accuracy of the trained model and may be defined as the weighted harmonic mean of the precision and recall of the trained model. The evaluation metrics may include accuracy, precision and recall, which may be interactively selected by an expert and or developer. For example, the accuracy of each trained model may be measured based on a cross-validation procedure and the performance score generated by each trained model. As illustrated in FIG. 5, XGBoost may be trained with three hundred (300) features extracted from the original data 202. In the illustrated example, the performance of the trained XGBoost model may be represented as having an F1 score of 0.8.

As shown in the illustrated example, the model training results may provide an explainability description of the trained model. The explainability description may describe explainability properties of the outputs of the models that the expert should be able to understand and use for selecting one or more models. The explainability of the output of a trained model may be evaluated based on various properties and or parameters, such as feature transparency on the model output, interpretability, feature inclemency on a prediction, etc. The explainability properties of each trained model may be generated by a hard-coded ranking of the trained models. For example, as illustrated in FIG. 5, the output of the trained XGBoost model may provide model explainability properties such as, e.g., “users may read a list of features, but the features may be more than they can follow. A list of features may influence in diverse ways such that it is hard to follow.” Thus, with the accuracy and explainability properties, the trained model may be evaluated to determine the benefit of the trained model. The benefits may include whether the trained model is fully transparent and or whether any mistakes may be avoided using the model. Further, an example list of the parameters for each model may be identified or derived as a result of the training process. The list of parameters may be dependent on the methods used. For example, the example parameters may be the number and depth of trees in a “random forest” or the regularization parameters for logistic regression.

Returning again to FIGS. 2 and 4, at step 408, application server 120 may execute models or algorithms of the platform 200 to determine an explainable model 218 as a recommended model from the set of the trained models 214 based on at least one of the accuracy value and the explainability properties. The application server 120 may select and or determine the explainable model 218 from the set of trained models 214 based on a trade-off decision made between the accuracy and explainability properties of the trained models 214. The system may conduct model evaluation 216 by performing automated ranking and assessment of models and parameters so that the best list of possible options may be determined for the expert of developer based on the trade-off between performance and explainability. As a result, the system may only keep model options that are Pareto-optimal with respect to the explainability and multi-objective optimization.

Referring to FIGS. 2 and 6, an example process 600 that may conduct model evaluation 216 to determine and produce an explainable model 218 in accordance with some embodiments of the present disclosure is now described. As a partial feature of the machine learning pipeline process, the process 600 may be implemented as a sequence of operations that can be performed by one or more computers including hardware, software, or a combination in the above described systems. Thus, the described operations may be performed with computer-executable instructions under control of one or more processors. The order in which the operations are described is not intended to be construed as a limitation, and any number of the described operations can be combined in any order and/or in parallel to implement the process. The process 600 may describe some embodiments in which a trade-off decision or compromise may be made to determine an explainable model 218 such that the explainable model 218 may provide the a best trade-off between model accuracy and explainability.

At step 602, application server 120 may execute models or algorithms of the platform 200 to rank the accuracy value or performance scores and assess explainability properties of each trained model. A set of trained models 214 may be ranked using a composite score of accuracy (or other performance metrics) and explainability properties to form a ranked set of trained models. In some embodiments, the weight that each explainability and accuracy obtained in the ranking may be considered to make a trade-off decision based on the case or training purpose and or how sensitive the model is to explanations.

At step 604, a trade-off decision may be made based on the rankings to determine whether to utilize the explainability properties to determine a subset of the trained models (not shown) from the set of trained models 214. The subset of the trained models may be determined based on a trade-off between accuracy and explainability of the models.

At step 606, when it is determined to utilize the explainability property to determine the subset of the trained models, application server 120 may determine a subset of trained models from the set of the trained models 214. Each trained model included in the subset of trained models may be selected if it has an explainability property above a predetermined explainability threshold.

At step 608, the application server 120 may determine or select an explainable model 218 as the trained model with a maximum accuracy from the subset of the trained models.

In one embodiment, a typical case of a multi-objective process may be used to select acceptable models such that each model in the subset of trained models passes (i.e., exceeds) the explainability threshold for one objective (e.g., explainability) to be acceptable. Further, the best model option from the remaining model options may be chosen based on another objective (e.g., accuracy, F1 score, etc.). Accuracy of the subset of the trained models may be ranked to determine models that exceed a predetermined accuracy threshold having at least a predetermined percentage of accuracy. The final selected explainable model 218 may be the model with the best accuracy and or a maximum performance score in the subset of the trained models. For example, as illustrated in FIG. 5, a subset of the GA2M model listed and the COREL model may be selected as a subset of the trained models because both of them have the benefit of full transparency. Further, the performance scores (e.g., F1 score) of both models may be ranked so that a model with the higher performance score may be selected to be a final model. For example, the GA2M model listed in FIG. 5 may be selected to be a final explainable model.

At step 610, based on the ranking of step 602, when it is determined not to utilize the explainability properties to determine the subset of the trained models (i.e., a “No” at step 604), the application server 120 may determine a subset of trained models from the set of the trained models 214 based on accuracy. For example, each model in the subset of trained models may be determined or selected by having a respective accuracy above a predetermined accuracy threshold.

At step 612, the application server 120 may determine or select an explainable model 218 as the trained model with best explainability properties from the subset of the trained models.

In one embodiment, a typical case of a multi-objective process may be used to select acceptable models such that each model in the subset of trained models passes (i.e., exceeds) the predetermined accuracy threshold for one objective (e.g., accuracy). The predetermined accuracy threshold may be set to have at least a percentage of accuracy or a predetermined performance score. For example, the model ranking may be conducted first based on accuracy values or performance scores when explainability is not important. Further, the best option from the remaining model options may be chosen based on another objective (e.g., explainability). The explainability of the subset of the trained models may be ranked or evaluated to determine models that exceed a predetermined explainability threshold. The most explainable or simplest model may be selected as the final explainable model 218 from the subset of the trained models.

The input-output relationship of each trained model may be used to show and or describe where each model fails or succeeds such that an expert and or developer may get a better understanding of the areas of failure. The model training results may be analyzed to show and determine the accuracy-explainability trade-off. For example, the model training results may enable an expert and or developer understand what is the most explainable model they can get at any given loss of accuracy and allow the expert and or developer to probe the different models and see where and how they fail.

In some embodiments, the expert and or developer may be allowed to test the fairness of the different models, by querying and testing for differences in distributions of outcomes in custom cross-sections of the data.

At step 614, the selected model with explainable AI may be deployed into a practical application, which may be used to provide real-time machine learning solutions in different technical and engineering areas. The deployed machine learning model with explainable AI may be used for real-time decision making of machine learning analysis in response to various data processing and analysis requests received by the application server 120 over the network 110. For example, a loan engine may be originally based on a random forest classifier that may not provide the necessary level of explainability for regulatory purposes and for users. By utilizing the Auto-XAI pipeline method disclosed herein, the machine learning pipeline platform 200 may predict and generate a simpler and explainable machine learning method. The simpler and explainable machine learning method may be operated as a loan or risk engine that may be accurate and easy to explain, thus making the users happier and more trusting.

The XAI pipeline platform described herein may provide technical advantages, such as providing a list of models and parameters that may be good alternatives to each other and that may be evaluated and selected based on the trade-off between accuracy and explainability. The automated machine learning solutions provided by the XAI pipeline platform 200 may keep track of the best model while running many options and conducting parameter searches.

Embodiments described herein may improve automated machine learning in various technical fields by combining Auto-ML techniques and explainable AI methods to produce a XAI pipeline that converts any model to a model with XAI without experts and or developers to make the complicated and tough design choices.

The embodiments described herein may improve human readability of an explainable AI system. Embodiments described herein may facilitate user understanding of the machine learning models and the representations of the data that machine learning models use to generate accuracy and explainability made by the explainable machine learning pipeline. Further, the embodiments described herein may efficiently increase the processing speed of generating explainable machine learning solutions based on the trade-off between accuracy and explainability of different machine learning models of the AI system. The embodiments described herein may effectively improve decision-making reliability based on explainable machine learning solutions.

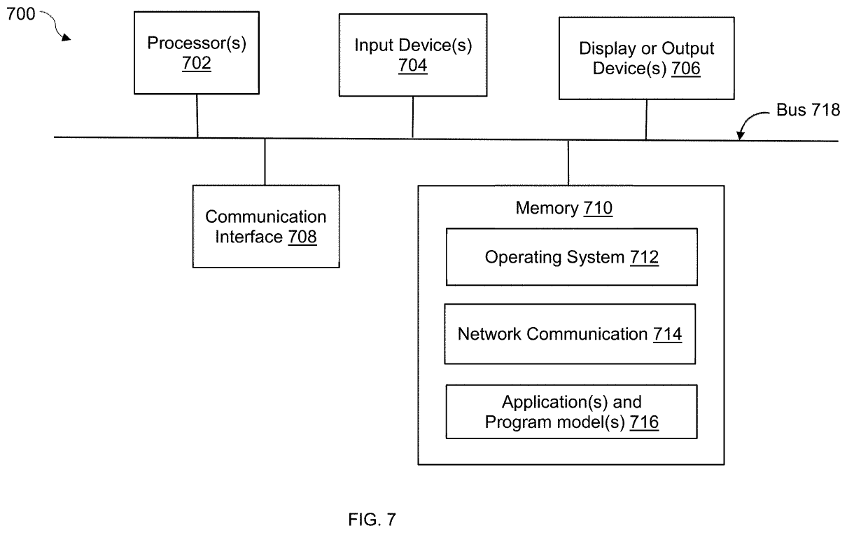

FIG. 7 is a block diagram of an example computing device 700 that may be utilized to execute embodiments to implement processes including various features and functional operations as described herein. For example, computing device 700 may function as application server 120, computing devices 130 or a portion or combination thereof in some embodiments. The computing device 700 may be implemented on any electronic device to execute software applications derived from program instructions for the XAI pipeline platform 200. The computing device 700 may include but is not limited to personal computers, servers, smart phones, media players, electronic tablets, game consoles, mobile devices, email devices, etc. In some implementations, the computing device 700 may include one or more processors 702, one or more input devices 704, one or more display or output devices 706, one or more communication interfaces 708, and memory 710. Each of these components may be coupled by bus 718, or in the case of distributed computer systems, one or more of these components may be located remotely and accessed via a network.

Processor(s) 702 may use any known processor technology, including but not limited to graphics processors and multi-core processors. Suitable processors for the execution of a program of instructions may include, by way of example, both general and special purpose microprocessors, and the sole processor or one of multiple processors or cores, of any kind of computer. Generally, a processor may receive instructions and data from a read-only memory or a random access memory or both. The essential elements of a computer may include a processor for executing instructions and one or more memories for storing instructions and data. Generally, a computer may also include, or be operatively coupled to communicate with, one or more non-transitory computer-readable storage devices for storing data files; such devices include magnetic disks, such as internal hard disks and removable disks; magneto-optical disks; and optical disks. Storage devices suitable for tangibly embodying computer program instructions and data may include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, ASICs (application-specific integrated circuits).

Input device 704 may be any known input device technology, including but not limited to a keyboard (including a virtual keyboard), mouse, track ball, and touch-sensitive pad or display. To provide for interaction with a user, the features and functional operations described in the disclosed embodiments may be implemented on a computer having a display device 706 such as a CRT (cathode ray tube) or LCD (liquid crystal display) monitor for displaying information to the user and a keyboard and a pointing device such as a mouse or a trackball by which the user can provide input to the computer. Display device 706 may be any known display technology, including but not limited to display devices using Liquid Crystal Display (LCD) or Light Emitting Diode (LED) technology.

Communication interfaces 708 may be configured to enable computing device 700 to communicate with other computing or network device across a network, such as via a wired connection, a wireless connection, or a combination of wired and wireless connections. For example, communication interfaces 708 may include an Ethernet interface, an optical interface, a coaxial interface, an infrared interface, a radio frequency (RF) interface, a universal serial bus (USB) interface, a Wi-Fi interface, a cellular network interface, or the like.

Memory 710 may be any computer-readable medium that participates in providing computer program instructions and data to processor(s) 702 for execution, including without limitation, non-volatile storage media (e.g., optical disks, magnetic disks, flash drives, etc.), or volatile storage media (e.g., SDRAM, ROM, etc.). Memory 710 may include various non-transitory computer-readable instructions for implementing an operating system 712 (e.g., Mac OS®, Windows®, Linux), network communication 714, and Application(s) and program modules 716, etc. One program module 716 may be an auto-XAI module 124 of FIG. 1 or Auto-XAI module 212 in FIG. 2. The operating system may be multi-user, multiprocessing, multitasking, multithreading, real-time, and the like. The operating system may perform basic tasks, including but not limited to: recognizing input from input device 704; sending output to display device 706; keeping track of files and directories on memory 710; controlling peripheral devices (e.g., disk drives, printers, etc.) which can be controlled directly or through an I/O controller; and managing traffic on bus 718. Bus 718 may be any known internal or external bus technology, including but not limited to ISA, EISA, PCI, PCI Express, NuBus, USB, Serial ATA or FireWire.

Network communications instructions 714 may establish and maintain network connections (e.g., software applications for implementing communication protocols, such as TCP/IP, HTTP, Ethernet, telephony, etc.).

Application(s) and program modules 716 may include software application(s) and different functional program modules which are executed by processor(s) 702 to implement the processes described herein and/or other processes. The program modules may include but not limited to software programs, objects, components, data structures that are configured to perform particular tasks or implement particular data types. The processes described herein may also be implemented in operating system 712.

Communication between various network and computing devices may be facilitated by one or more application programming interfaces (APIs). APIs of system 700 may be proprietary and/or may be examples available to those of ordinary skill in the art such as Amazon® Web Services (AWS) APIs or the like. The API may be implemented as one or more calls in program code that send or receive one or more parameters through a parameter list or other structure based on a call convention defined in an API specification document. A parameter may be a constant, a key, a data structure, an object, an object class, a variable, a data type, a pointer, an array, a list, or another call.

The features and functional operations described in the disclosed embodiments may be implemented in one or more computer programs that may be executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program may be written in any form of programming language (e.g., Objective-C, Java), including compiled or interpreted languages, and it may be deployed in any form, including as a stand-alone program or as a module, component, subroutine, or other unit suitable for use in a computing environment.

The described features and functional operations described in the disclosed embodiments may be implemented in a computer system that includes a back-end component, such as a data server, or that includes a middleware component, such as an application server or an Internet server, or that includes a front-end component, such as a user computer having a graphical user interface or an Internet browser, or any combination thereof. The components of the system may be connected by any form or medium of digital data communication such as a communication network. Examples of communication networks include, e.g., a telephone network, a LAN, a WAN, and the computers and networks forming the Internet.

The computer system may include user computing devices and application servers. A user or client computing device and server may generally be remote from each other and may typically interact through a network. The relationship of client computing devices and server may arise by virtue of computer programs running on the respective computers and having a client-server relationship to each other.

While various embodiments have been described above, it should be understood that they have been presented by way of example and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims.

In addition, it should be understood that any figures which highlight the functionality and advantages are presented for example purposes only. The disclosed methodology and system are each sufficiently flexible and configurable such that they may be utilized in ways other than that shown.

AI though the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A method implemented by a computing system, the computing system comprising one or more processors and one or more non-transitory computer-readable storage devices having computer-executable computer instructions which, when executed by the one or more processors, cause the one or more processors to perform a machine learning pipeline process comprising:
Receiving feature datasets from a database;
obtaining a set of models, each model being selected to be compatible with at least one of the feature datasets;
training each model of the set of models with the at least one feature dataset to create a set of trained models;
generating an accuracy value and explainability properties for each model of the set of the trained models; and
selecting an explainable model as a recommended model from the set of the trained models based on the accuracy value and the explainability properties.

2. The method of claim 1, wherein the machine learning pipeline process further comprises:
ranking the set of the trained models based on the accuracy value and the explainability properties of each model in the set of trained models; and
utilizing the explainability properties of the ranked set of trained models to define a subset of the trained models from which to select the explainable model.

3. The method of claim 2, wherein said utilizing step further comprises:
determining, from the ranked set of trained models, the subset of trained models by selecting trained models having respective explainability properties above a predetermined explainability threshold; and
determining, from the subset of the trained models, the explainable model as the trained model with a maximum accuracy value.

4. The method of claim 1, wherein the machine learning pipeline process further comprises:
ranking the set of trained models based on the accuracy value and the explainability properties of each model in the set of trained models; and
utilizing the accuracy value of the ranked set of trained models to define a subset of the trained models from which to select the explainable model.

5. The method of claim 4, wherein said utilizing step further comprises:
determining, from the ranked set of trained models, the subset of trained models by selecting trained models having an accuracy value above a predetermined accuracy threshold; and
determining, from the subset of the trained models, the explainable model as the trained model with the best explainability properties.

6. The method of claim 1, wherein the accuracy value of each trained model is measured based on a cross-validation procedure and a performance score of each trained model and the explainability properties of each trained model are generated by a hard-coded ranking of the trained models.

7. The method of claim 1, wherein each feature comprises a flag to indicate whether the feature has a semantic meaning that may be used as an explanation for a trained model.

8. A computing system, comprising:
one or more processors; and
one or more non-transitory computer-readable storage devices storing computer-executable instructions, the instructions operable to cause the one or more processors to perform a machine learning pipeline process comprising:
receiving feature datasets from a database;
obtaining a set of models, each model being selected to be compatible with at least one of the feature datasets;
training each model of the set of models with the at least one feature dataset to create a set of trained models;
generating an accuracy value and explainability properties for each model of the set of the trained models; and
selecting an explainable model as a recommended model from the set of the trained models based on the accuracy value and the explainability properties.

9. The system of claim 8, wherein the machine learning pipeline process further comprises:
ranking the set of the trained models based on the accuracy value and the explainability properties of each model in the set of trained models; and
utilizing the explainability properties of the ranked set of trained models to define a subset of the trained models from which to select the explainable model.

10. The system of claim 9, wherein said utilizing step further comprises:
determining, from the ranked set of trained models, the subset of trained models by selecting trained models having respective explainability properties above a predetermined explainability threshold; and
determining, from the subset of the trained models, the explainable model as the trained model with a maximum accuracy value.

11. The system of claim 8, wherein the machine learning pipeline process further comprises:
ranking the set of trained models based on the accuracy value and the explainability properties of each model in the set of trained models; and
utilizing the accuracy value of the ranked set of trained models to define a subset of the trained models from which to select the explainable model.

12. The system of claim 11, wherein said utilizing step further comprises:
determining, from the ranked set of trained models, the subset of trained models by selecting trained models having an accuracy value above a predetermined accuracy threshold; and
determining, from the subset of the trained models, the explainable model as the trained model with the best explainability properties.

13. The system of claim 8, wherein the accuracy of each trained model is measured based on a cross-validation procedure and a performance score of each trained model; and the explainability property of each trained model is generated by a hard-coded ranking of the trained models.

14. The system of claim 10, wherein each feature comprises a flag to indicate whether the feature has a semantic meaning that may be used as an explanation for a trained model.

15. A computing system, comprising:
one or more processors; and
one or more non-transitory computer-readable storage devices storing computer-executable instructions, the instructions operable to cause the one or more processors to perform a machine learning pipeline process comprising:
receiving feature datasets from a database;
obtaining a set of models, each model being selected to be compatible with at least one of the feature datasets;
training each model of the set of models with the at least one feature dataset to create a set of trained models;
generating an accuracy value and explainability properties for each model of the set of the trained models;
ranking the set of the trained models based on the accuracy value and the explainability properties of each model in the set of trained models; and
selecting an explainable model as a recommended model from the set of the trained models based on the accuracy value and the explainability properties of the ranked set of trained models.

16. The system of claim 15, wherein the machine learning pipeline process further comprises:
utilizing the explainability properties of the ranked set of trained models to define a subset of the trained models from which to select the explainable model.

17. The system of claim 16, wherein said utilizing step further comprises:
determining, from the ranked set of trained models, the subset of trained models by selecting trained models having respective explainability properties above a predetermined explainability threshold; and
determining, from the subset of the trained models, the explainable model as the trained model with a maximum accuracy value.

18. The system of claim 15, wherein the machine learning pipeline process further comprises:
utilizing the accuracy value of the ranked set of trained models to define a subset of the trained models from which to select the explainable model.

19. The system of claim 18, wherein said utilizing step further comprises:
determining, from the ranked set of trained models, the subset of trained models by selecting trained models having an accuracy value above a predetermined accuracy threshold; and
determining, from the subset of the trained models, the explainable model as the trained model with the best explainability properties.

20. The system of claim 15, wherein each feature comprises a flag to indicate whether the feature has a semantic meaning that may be used as an explanation for a trained model.
